(19) United States
(12) Patent Application Publication
(10) Pub. No.: US 2026/0004085 A1
(43) Pub. Date: Jan. 1, 2026

(54) TRAINED MULTI-DOMAIN LANGUAGE MODEL FOR CONTENT MODERATION OF A PRIMARY LANGUAGE MODEL

(71) Applicant: Intuit Inc., Mountain View, CA (US)

(72) Inventors: Tharathorn RIMCHALA, San Francisco, CA (US); Runhua ZHAO, Milpitas, CA (US)

(73) Assignee: Intuit Inc., Mountain View, CA (US)

(21) Appl. No.: 18/759,767

(22) Filed: Jun. 28, 2024

(51) Int. Cl. G06F 40/40; G06F 16/242

(52) U.S. Cl. CPC G06F 40/40; G06F 16/243

(57) ABSTRACT

A method including receiving a query for a primary language model. An inference prompt is generated and a query domain is identified. A trained multi-domain language model is applied to the inference prompt according to the inference prompt and the query domain to generate an output decision. The query is routed to a routing process according to the output decision.

### CROSS-REFERENCE TO RELATED APPLICATIONS

This application is related to U.S. Application Ser. No. ______, filed on the same date herewith, and identified by attorney matter number 2413160US; 752640 INU-879.

### BACKGROUND

A language model is a type of machine learning model, which is sometimes referred to as artificial intelligence. Specifically, a language model processes natural language text as input and generates natural language text as output. An example of a language model is a large language model (e.g., CHATGPT®). Language models also are commonly used as online chatbots.

Abuse of language models is a growing problem. For example, some users may enter inappropriate queries to the language model. Inappropriate queries are queries that have little to do with the purpose of the language model. For example, a chatbot may be made available to answer simple questions about tax facts, but a user may enter a query about inappropriate behavior in a social setting. In a few cases, a malicious user may deliberately attempt to abuse the model, such as by attempting a prompt injection attack.

A content moderation model may address the abuse of language models. A content moderation model is often another machine learning model, and in particular another language model. The content moderation model output, however, is a determination of whether the query should be blocked or permitted to serve as input to the primary language model to which the query was submitted.

However, a technical issue with content moderation models is that content moderation models are application specific. For example, if a company operates multiple chatbots for multiple products (e.g., software applications), then each chatbot is monitored by a different moderation model specifically trained to moderate a corresponding chatbot. Furthermore, each moderation model may be trained on specific training data that is specific to a domain (e.g., a software application, a subject, etc.).

However, developing and maintaining multiple moderation models is expensive, and whenever a new domain or a new chatbot is added to a system, a new moderation model is developed. The costs for maintaining and creating multiple moderation models may be undesirable. However, no single moderation model is accurate enough (as determined by a business) to moderate the multiple language models of an organization.

### SUMMARY

One or more embodiments provide for a method. The method includes receiving a query for a primary language model. The method also includes applying a server controller to the query to generate an inference prompt and to identify a query domain. The method also includes applying a trained multi-domain language model to the inference prompt according to the inference prompt and the query domain to generate an output decision. The method also includes routing the query to a routing process according to the output decision.

One or more embodiments also provide for a system. The system includes a processor and a data repository in communication with the processor. The data repository stores a query for a primary language model. The data repository also stores an inference prompt. The data repository also stores a query domain. The data repository also stores an output decision. The system also includes a server controller which, when executed by the processor receives the query and generates the inference prompt and identifies the query domain. The system also includes a trained multi-domain language model which, when executed by the processor, generates the output decision. The system also includes a routing process which, when executed by the processor, routes the query according to the output decision.

One or more embodiments provide for another method. The method includes receiving a query for a primary language model. The method also includes applying a server controller to the query to generate an inference prompt and to identify a query domain. The method also includes selecting a selected set of domain adapter layers from among a set of domain general adapter layers and sets of domain specific adapter layers of a trained multi-domain language model. The trained multi-domain language model further includes a set of base layers separate from the set of domain general adapter layers and the sets of domain specific adapter layers. The method also includes applying the trained multi-domain language model to the query according to the inference prompt and the query domain to generate an output decision. Applying the trained multi-domain language model further includes applying the inference prompt to the set of base layers, the set of domain general adapter layers, and the sets of domain specific adapter layers. Applying the trained multi-domain language model further includes multiplying, by zero, outputs of the set of domain general adapter layers and the sets of domain specific adapter layers, other than the selected set of domain adapter layers. Applying the trained multi-domain language model further includes combining, into a combined output, a selected output of the selected set of domain adapter layers with a base output of the set of base layers. Applying the trained multi-domain language model further includes generating structured text, containing a content moderation prediction and an output decision, based on the combined output. The method also includes routing the query to a routing process according to the output decision. Routing further includes blocking or permitting the query from reaching the primary language model according to the structured text.

Other aspects of one or more embodiments will be apparent from the following description and the appended claims.

### BRIEF DESCRIPTION OF DRAWINGS

FIG. 1A and FIG. 1B show a computing system, in accordance with one or more embodiments.

FIG. 2 shows a flowchart of a method for using a trained multi-domain language model for content moderation of a primary language model, in accordance with one or more embodiments.

FIG. 3 and FIG. 4 show a trained multi-domain language model, in accordance with one or more embodiments.

FIG. 5 shows a data flow for using a trained multi-domain language model for content moderation of a primary language model, in accordance with one or more embodiments.

FIG. 6 shows an example of a prompt for use with a trained multi-domain language model for content moderation of a primary language model, in accordance with one or more embodiments.

FIG. 7A and FIG. 7B show a computing system and network environment, in accordance with one or more embodiments.

Like elements in the various figures are denoted by like reference numerals for consistency.

### DETAILED DESCRIPTION

One or more embodiments are directed to a method for using a trained multi-domain language model for content moderation. The trained multi-domain language model may be a single machine learning model that may be used to moderate the content of multiple different primary language models. A primary language model is a model to which a query (e.g., a query) was submitted, and the trained multi-domain language model of one or more embodiments may be characterized as a moderation model.

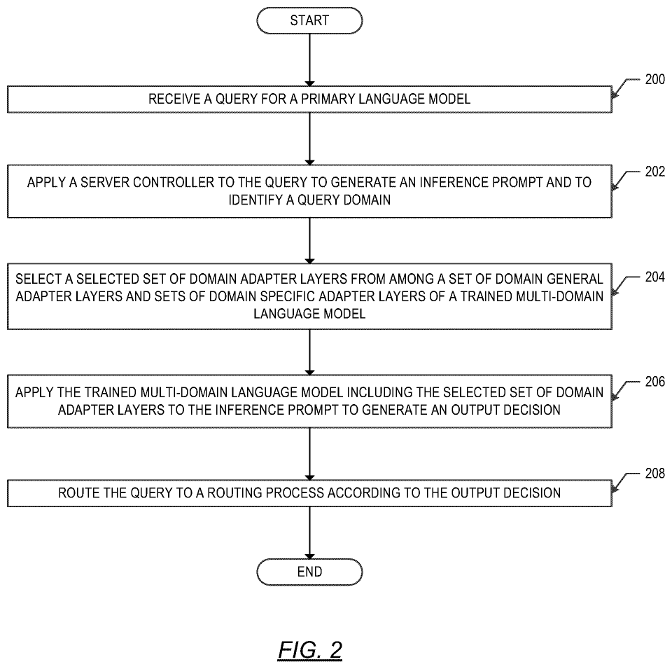

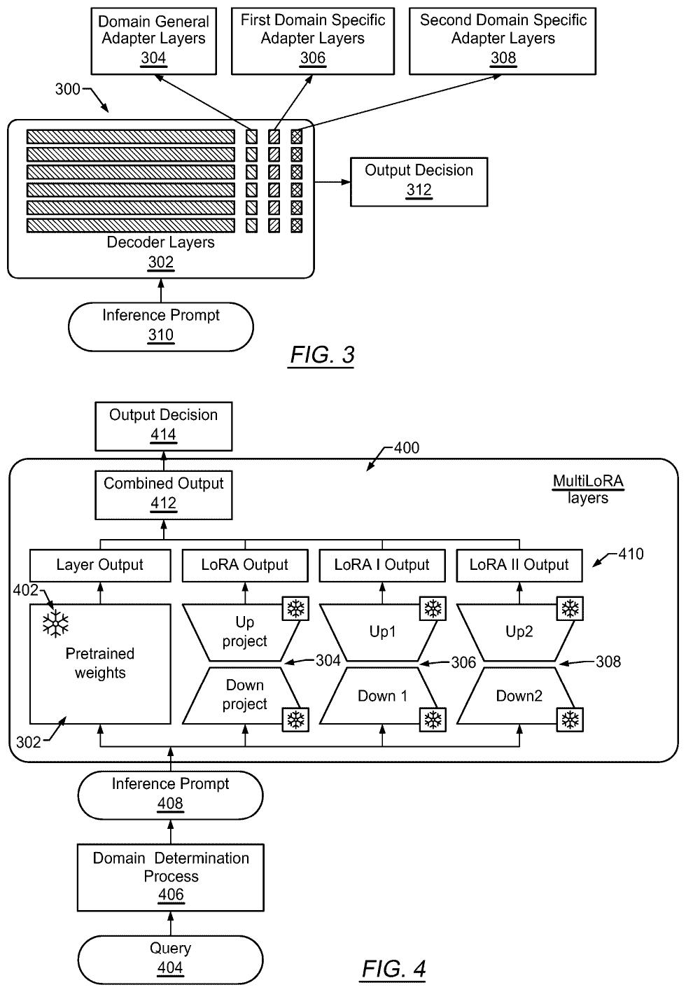

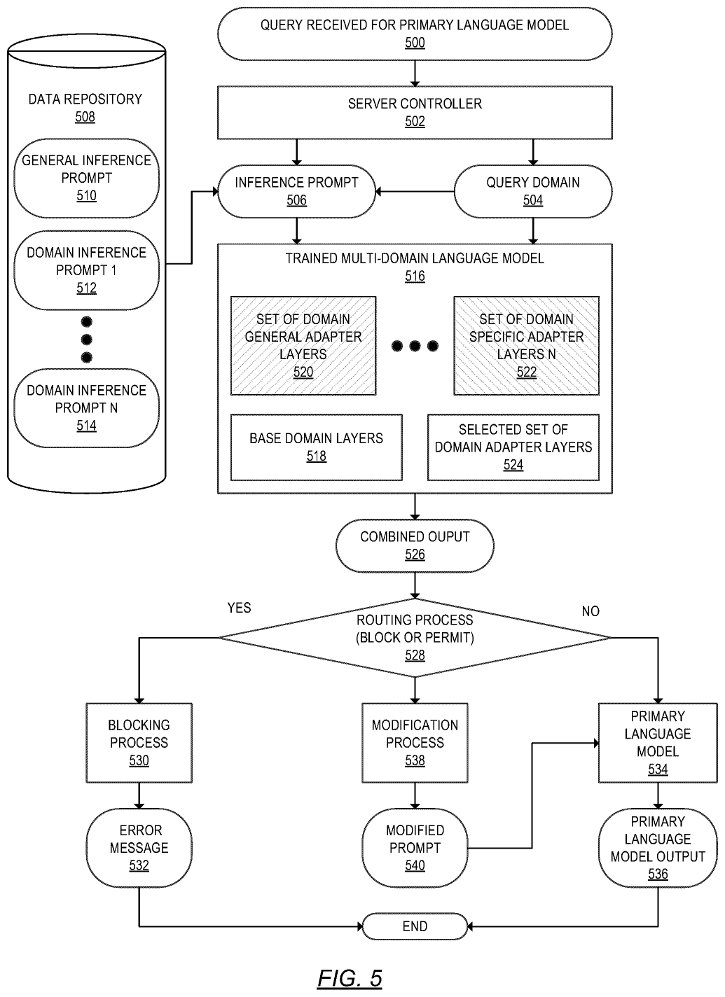

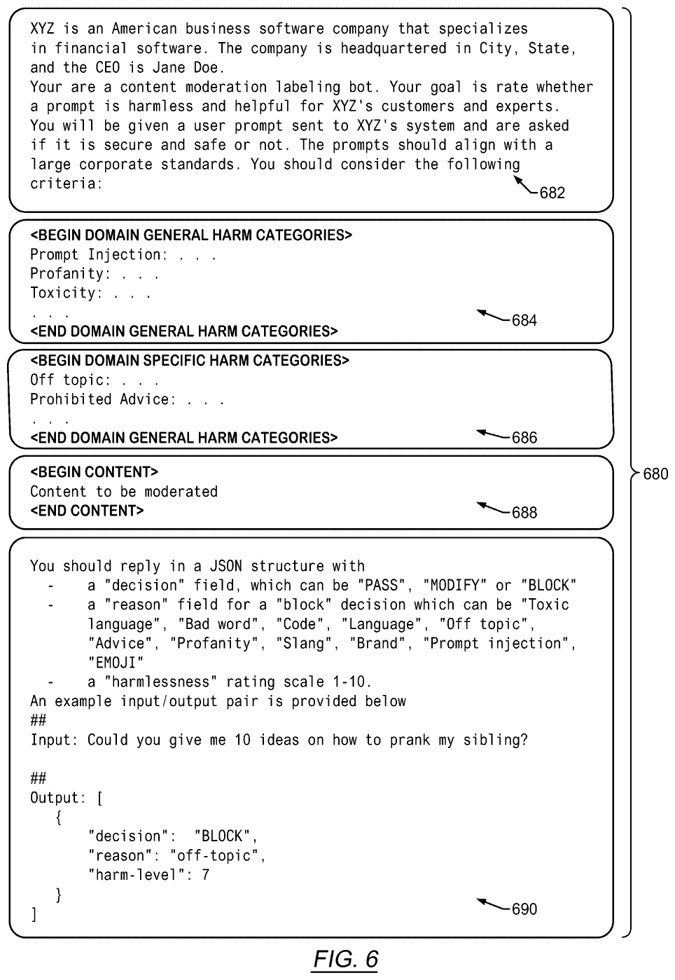

The trained multi-domain language model of one or more embodiments is described with respect to the figures. An example of a trained multi-domain language model according to one or more embodiments is described with respect to FIG. 3 and FIG. 4. An example of the data flow of the trained multi-domain language model is shown in FIG. 5, together with an example of a query in FIG. 6 that may be used for the data flow shown in FIG. 5.

Before summarizing the training of the trained multi-domain language model, a brief description of the structure and the operation of the trained multi-domain language model is presented. The trained multi-domain language model of one or more embodiments may be a language model having multiple domains. Each domain is composed of multiple layers. For each domain, the input to the first layer is a query and the output of a second layer (i.e., the subsequent layer) is a prediction. The output of the second layer serves as input to the third layer, and so on. Thus, the output of an intervening layer serves as input to the subsequent layer. The output of the ultimate layer of the trained multi-domain language model is a prediction of interest (e.g., to block or permit the query).

The different domains of the trained multi-domain language model assist with accurately handling a variety of different domains to which the query may be assigned. The domains include a set of domain general adapter layers that is applied to general harms common to all domains. The domains also include one or more sets of domain specific adapter layers that are applied only to specific queries determined to be in a corresponding specific domain. Once the query is assigned to a corresponding domain, then the corresponding domain is applied to the query (in addition to the application of the set of domain general adapter layers to the query). Other domain specific adapter layers (i.e., those sets of domain specific adapter layers to which the query is not assigned) are excluded during execution of the model.

The training of the trained multi-domain language model of one or more embodiments proceeds by training the set of domain general adapter layers on a training dataset. However, the training dataset is also grouped into domain subsets. Each domain subset is a group of the training data that has been determined to be relevant to a set of domain specific adapter layers.

Each of the sets of domain specific adapter layers of the trained multi-domain language model are trained on the corresponding domain subsets of the training data, to the exclusion of other data in the training dataset. In other words, each of the sets of domain specific adapter layers of the trained multi-domain language model is trained on a corresponding data subset that represents domain specific data contained in the training data.

Then, the layers of the trained set of domain general adapter layers and the corresponding layers of each of the sets of domain specific adapter layers are combined. The result is the trained multi-domain language model.

In use, the trained multi-domain language model is a machine learning model that may be used to predict whether queries should be blocked or permitted, regardless of which domain any one of the queries may fall, but without sacrificing accuracy of the ultimate prediction. In this manner, one or more embodiments address the technical issues described above by replacing multiple domain specific content moderation models with a single, improved content moderation model.

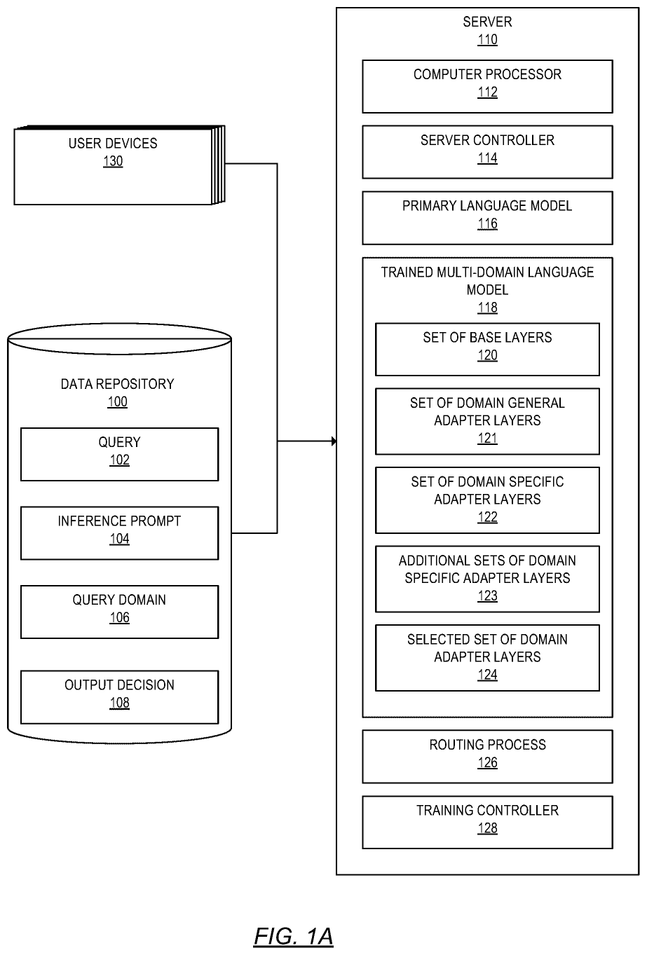

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) also stores a query (102). The query (102) is a prompt, entered by the user, submitted to the primary language model (116) (defined below). In other words, the query (102) is the query, text, submission, etc. that the user submits to the primary language model (116) in order to receive a response from the primary language model (116). In an example, the query (102) may be a tax question submitted to a chatbot which generates answers to user queries using the primary language model (116). In one or more embodiments, moderating use of the primary language model (116) may be accomplished by blocking or permitting the query (102) from reaching the primary language model (116).

In general, a prompt is an instruction, written in natural language text, to a language model (e.g., either the primary language model (116) or the trained multi-domain language model (118)). A prompt may include a number of different sections. For example, a prompt may include a system message that provides general instructions regarding how the language model should treat or perform a specific instruction. A prompt may include the data to be acted upon (e.g., the query (102)). A prompt may include a reference to the data to be acted upon (e.g., point to a data repository or non-transitory computer readable storage medium where data is stored). A prompt may include domain specific instructions, as explained below. A prompt may include a section which instructs the language model regarding how the output is to be structured. For example, a prompt may instruct a language model to place the output of the language model in an object notation language format, a natural language format, or some other format. An example of the query (102) is shown in FIG. 6.

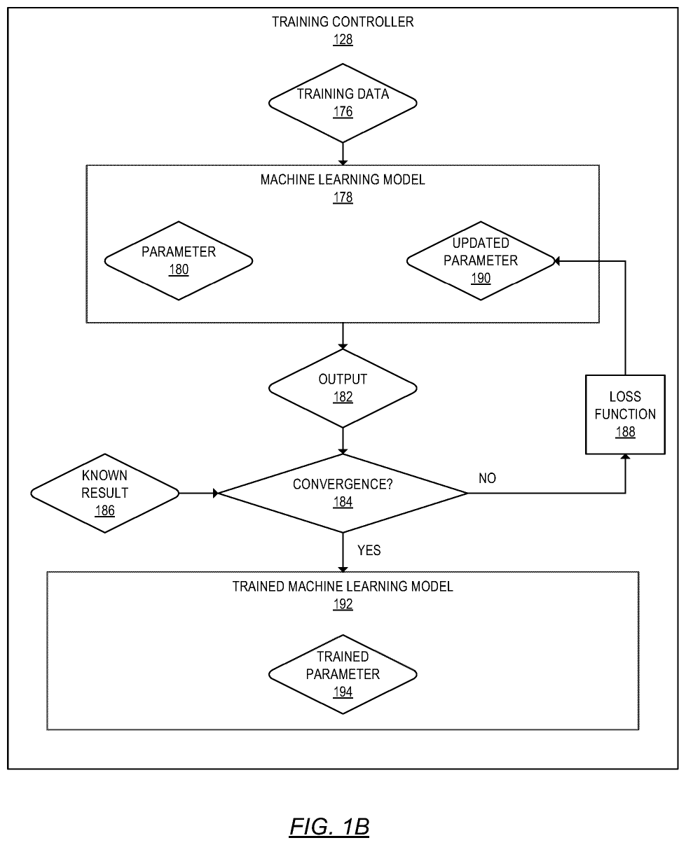

The data repository (100) also stores an inference prompt (104). The inference prompt (104) is a prompt submitted to a trained multi-domain language model (118) (defined below) in order to determine an inference regarding the query (102). The inference prompt (104) is automatically generated based on the query (102), as described with respect to FIG. 2.

The inference prompt (104) may be one of several different types of prompts. The inference prompt (104) may be a general inference prompt. A general inference prompt is a prompt to a language model that contains general instructions to the trained multi-domain language model (118), regardless of the domain to which the query (102) is assigned. The general inference prompt also includes a reference to the query (102). In other words, when the trained multi-domain language model (118) is applied to the inference prompt (104), the trained multi-domain language model (118) considers the text of the query (102) in view of the instructions provided in the general inference prompt. The general inference prompt, in an embodiment, may be used when no specific domain for the query is found during the method of FIG. 2, or under some other predefined conditions.

The query (102) also may be a domain specific prompt. A domain specific prompt is instructions to the language model when the query (102) is assigned to a specific domain. In other words, the domain specific prompt includes instructions to the trained multi-domain language model (118) that are specific to the domain to which the query (102) is assigned when the trained multi-domain language model (118) executes according to the instructions in the inference prompt (104).

The domain specific prompt and the general inference prompt may be combined at execution time. For example, the domain specific prompt may be added to the general inference prompt, and the combined prompt submitted to the trained multi-domain language model (118). Additional details regarding the use and combination of different prompt types is described with respect to the method of FIG. 2 and the data flow of FIG. 5.

The data repository (100) also may store a query domain (106). The query domain (106) is an indicator coming from the metadata associated with the query to the chatbot or inferred at runtime which is then applied to the query (102). The indicator specifies a domain to which the query (102) belongs.

The nature of the domain may vary, depending on a specific implementation of one or more embodiments. In an example, the domain may be a type of application from which the query (102) was received. For example, the user may be using one of five different applications owned and operated by the organization owning and operating the system of FIG. 1A. The user may enter the query (102) via a first application of the five applications. The query domain (106) may be an identity of the first application.

However, different domain schemes may be used. For example, the domain may represent a determined subject area to which the query (102) belongs. For example, a language model (which may be the trained multi-domain language model (118) or some other language model) may determine a subject area, from among several predetermined subject areas, to which the query (102) belongs. In this case, the query domain (106) is the subject area to which the query (102) is assigned.

Use and handling of the query domain (106) is described with respect to FIG. 2 and FIG. 5. In particular, the query domain (106) may be used to determine the content of the inference prompt (104).

The data repository (100) also may store an output decision (108). The output decision (108) is the output of the trained multi-domain language model (118) with respect to content moderation of the primary language model (116). For example, the output decision (108) may be a structured text that contains content moderation predictions that can be used to determine whether to block or to permit the query (102) from reaching the primary language model (116). The output decision (108) also may be a modified version of the query with the harmful part removed or rephrased (102), in which case a modified version of the query (102) is submitted to the primary language model (116). Other variations are possible.

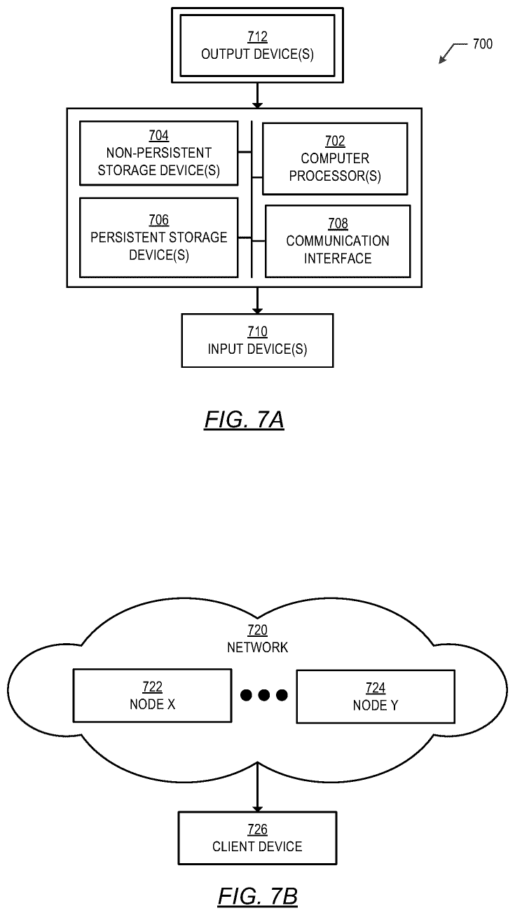

The system shown in FIG. 1A may include other components. For example, the system shown in FIG. 1A also may include a server (110). The server (110) is one or more computer processors, data repositories, communication devices, and supporting hardware and software. The server (110) may be in a distributed computing environment. The server (110) is configured to execute one or more applications, such as the primary language model (116), the trained multi-domain language model (118), the routing process (126), and the training controller (128). An example of a computer system and network that may form the server (110) is described with respect to FIG. 7A and FIG. 7B.

The server (110) includes a computer processor (112). The computer processor (112) is one or more hardware or virtual processors which may execute computer readable program code that defines one or more applications, such as the primary language model (116), the trained multi-domain language model (118), the routing process (126), and the training controller (128). An example of the computer processor (112) is described with respect to the computer processor(s) (702) of FIG. 7A.

The server (110) also may include a server controller (114). The server controller (114) is software or application specific hardware which, when executed by the computer processor (112), controls and coordinates operation of the software or application specific hardware described herein. Thus, the server controller (114) may control and coordinate execution of the primary language model (116), the trained multi-domain language model (118), the routing process (126), and the training controller (128). Additionally, the server controller (114) may be responsible for coordinating the execution of various software components to implement the machine learning inference method described with respect to FIG. 2.

The server (110) may host a primary language model (116). The primary language model (116) is a natural language processing machine learning model. The primary language model (116) may be a large language model, such as CHATGPT®. However, many different language models may be used. The primary language model (116) may be, for example, a chatbot or some other application that uses a language model. Use of the primary language model (116) is described with respect to FIG. 2.

The server (110) also may host a trained multi-domain language model (118). The trained multi-domain language model (118) is a natural language processing machine learning model that includes multiple domains, as defined further below with respect to the set of base layers (120), the set of domain general adapter layers (121), the set of domain specific adapter layers (122), and the additional sets of domain specific adapter layers (123).

The term “trained” is used with respect to the trained multi-domain language model (118), because, in use, the trained multi-domain language model (118) is pre-trained and ready for the inference stage of machine learning when the model is applied to unknown data (e.g., the trained multi-domain language model (118) is ready to be applied to the query (102)). Training of the trained multi-domain language model (118) is described with respect to FIG. 1B.

Each of the multiple domains (e.g., the set of domain general adapter layers (121) and the set of domain specific adapter layers (122)) may include multiple layers. Each layer is computer program code that, when executed by the computer processor (112), performs a predetermined set of operations on the input of a previous layer. The input to the first layer may be the query (102). The output of the last layer of the last of the layers may be used in formulating the output decision (108). In an embodiment, as shown in FIG. 4, the output decision (108) may be a combination of the outputs of the last layers after passing the query through the set of base layers (120) interleaving with the selected set of domain adapter layers (124) (i.e., one of set of domain general adapter layers (121), the set of domain specific adapter layers (122) and the additional sets of domain specific adapter layers (123)).

Attention is now turned to defining the types of the sets of layers of the trained multi-domain language model (118). The trained multi-domain language model (118) may include a set of base layers (120). The set of base layers (120) are layers which are applied to each query considered by the trained multi-domain language model (118).

The set of domain general adapter layers (121) are layers of the trained multi-domain language model (118) that are applied to those queries which are assigned to be common across domains. Again, each layer is program code which processes an input and generates an output.

The domain general adapter layers are inserted in between layers of the base layers in an interleaving manner. When the multi-domain language model is executed for domain general content moderation, the query is fed into the embedding of the first layer. Then the embedding output is fed into the first base layer and the corresponding domain general adapter layer. The output from each base layer and the domain general adapter layer. Then the outputs of the base layer and the domain general adapter layer are combined and used as an input to the next layer. The process continues until the ultimate layer generates the final output of the set of layers. The final output of the ultimate layer is used to predict the sequence of tokens that form the content moderation output for domain general harm categories as structured texts.

The set of domain specific adapter layers (122), in turn, are layers of the trained multi-domain language model (118) that are applied to those queries which are assigned to the corresponding specific domain. Again, each layer is program code which processes an input and generates an output. The domain specific adapter layers are inserted in between layers of the base layers in an interleaving manner. When the multi-domain language model is executed for domain specific content moderation, the query is fed into the embedding of the first layer. Then the embedding output is fed into the first base layer and the corresponding domain specific adapter layer. The output from each base layer and the domain specific adapter layer. Then the outputs of the base layer and the domain specific adapter layer are combined and used as an input to the next layer. The process continues to repeat until the ultimate layer generates the final output of the set of layers. The final output of the ultimate layer is used to predict the sequence of tokens that form the content moderation output for domain specific harm categories as structured texts.

A distinguishing feature of the set of domain general adapter layers (121) and set of domain specific adapter layers (122), relative to the set of base layers (120), is that the set of base layers (120) is trained differently than the set of domain general adapter layers (121) or the set of domain specific adapter layers (122). Namely, the set of base layers (120) are trained on a complete training data set of unlabeled queries. However, the set of domain general adapter layers (121) and the set of domain specific adapter layers (122) (and any additional sets of domain specific adapter layers (123)) are trained on query-label pairs with a corresponding domain specific label. The subset of labels is specific to the domain to which the set of domain specific adapter layers (122) are assigned (e.g., the domain general, or one of the specific domains). Furthermore, during use, the output of the set of domain general adapter layers (121) or the set of domain specific adapter layers (122) are used when the query (102) is assigned to the same corresponding domain. However, the set of base layers (120) are used regardless of the domain to which the query (102) is assigned, whereas outputs of those sets of domain adapter layers to which the query was not assigned are discarded or not generated in the first place.

The additional sets of domain specific adapter layers (123) are similar to the set of domain specific adapter layers (122). However, the additional sets of domain specific adapter layers (123) form an additional set of layers of the trained multi-domain language model (118) that are trained on a corresponding set of domain-specific training data. Thus, for example, when the query (102) is assigned to a first domain, then the final output of the set of domain specific adapter layers (122) may be considered when determining the output decision (108). However, when the query (102) is assigned to a second domain, then the final output of one of the additional sets of domain specific adapter layers (123) may be considered in determining the output decision (108).

The trained multi-domain language model (118) also includes a selected set of domain adapter layers (124). The selected set of domain adapter layers (124) is one of the set of domain general adapter layers (121), the set of domain specific adapter layers (122) or the additional sets of domain specific adapter layers (123). However, if additional domains (i.e., additional sets of domain specific adapter layers) are present, then the selected set of domain adapter layers (124) may be selected from among the available different sets of domain adapter layers of the trained multi-domain language model (118). More specifically, the selected set of domain adapter layers (124) is the set of layers, other than the set of base layers (120), that is selected to contribute to the output decision (108) when the trained multi-domain language model (118) is applied to the query (102). The criteria for selecting the selected set of domain adapter layers (124) is described with respect to FIG. 2 and FIG. 5.

The outputs of passing the query through the set of base layers (120), interleaving with the set of domain general adapter layers (121), or with the set of domain specific adapter layers (122), or with the additional sets of domain specific adapter layers (123) is a sequence of tokens that forms a structured text representing the content moderation predictions as described with respect to FIG. 2. The structured text is used to determine whether to block or permit the query (102) with respect to the primary language model (116).

In a specific embodiment, the trained multi-domain language model (118) may be a large language model with multiple sets of adapter layers, such as a multi-LoRA model (the term “LoRA” means “multiple LOW Rank Adaptations”). However, other types of language models may be used, so long as the language model being used is separated into domains (e.g., the set of base layers (120), the set of domain specific adapter layers (122), or the additional sets of domain specific adapter layers (123)).

An example of the trained multi-domain language model (118) is shown in FIG. 3 and FIG. 4. Use of the trained multi-domain language model (118) is described with respect to FIG. 2.

The server (110) also may host a routing process (126). The routing process (126) is software or application specific hardware which, when executed by the computer processor (112), routes or performs some other action on the query (102) according to the output of the trained multi-domain language model (118). Thus, the routing process (126) may be program code to route or block the query (102) from reaching the primary language model (116), or program code to modify the query (102) before being transmitted to the primary language model (116).

The server (110) also may include a training controller (128). The training controller (128) is software or application specific hardware which, when executed by the computer processor (112), trains one or more machine learning models (e.g., the trained multi-domain language model (118) and the primary language model (116)). The training controller (128) is described in more detail with respect to FIG. 1B.

The system shown in FIG. 1A also may include one or more user devices (130). The user devices (130) may be considered remote or local. A remote user device is a device operated by a third-party (e.g., an end user of a chatbot) that does not control or operate the system of FIG. 1A. Similarly, the organization that controls the other elements of the system of FIG. 1A may not control or operate the remote user device. Thus, a remote user device may not be considered part of the system of FIG. 1A.

In contrast, a local user device is a device operated under the control of the organization that controls the other components of the system of FIG. 1A. Thus, a local user device may be considered part of the system of FIG. 1A.

In any case, the user devices (130) are computing systems (e.g., the computing system (700) shown in FIG. 7A) that communicate with the server (110). The query (102) may be received from one or more of the user devices (130). In another embodiment, one or more of the user devices (130) may be operated by a computer technician that services the various components of the system shown in FIG. 1A.

Attention is turned to FIG. 1B, which shows the details of the training controller (128) shown in FIG. 1A. The training controller (128) is a training algorithm, implemented as software or application specific hardware, that may be used to train one or more of the machine learning models described with respect to the computing system of FIG. 1A.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model is applied to unknown data (i.e., data for which the actual result is not known) in order to make predictions.

In one or more embodiments, the machine learning models may be applied to text. High dimensional vectors may be more memory intensive than text. Text is natural language text, as well as possibly numbers and special characters (e.g., “*”, “!,” “@,” etc.).

However, some machine learning models may be applied to vector data structures. A vector is a computer readable data structure. A vector may take the form of a matrix, an array, a graph, or some other data structure. However, a frequently used vector form is a one by N matrix, where each cell of the matrix represents the value for one feature. As described above, a feature is a topic of data (e.g., a color of an object, the presence of a word or alphanumeric text, a physical measurement type, etc.). A value is a numerical or other recorded specification of the feature. For example, if the feature is the word “cat,” and the word “cat” is present in a corpus of text, then the value of the feature may be “1” (to indicate a presence of the feature in the corpus of text).

In one or more embodiments, some of the data in the data repository (100) of FIG. 1A may be stored in the form of one or more vectors. For example, the output decision (108) may be converted from natural language into vectors as part of executing the multi-domain language model (132) according to the instructions in the inference prompt (104).

Returning to the operation of the training controller (128), training starts with training data (176), which may be expressed in vector form. The training data (176) may be a domain general labeled dataset, a domain specific labeled dataset, and an unlabeled dataset, expressed in vector form or text form.

The training data is labeled. The labels represent a known result. Thus, a label applied to a query in the domain general labeled dataset may be a structured text containing the content moderation labels for the different abuse categories.

Thus, the training data (176) may be data for which the final result is known. The final result may be represented as a structured text that specifies whether the query belongs to any abuse categories. For example, when the multi-domain language model (132) is called during training to predict whether a query (123A) present in the domain general labeled dataset contains any abuse among the domain general abuse categories (152), the multi-domain language model (132) generates the prediction as structured text. If the prediction does not match the label, then the parameter values of the layers in the first set of domain specific adapter layers (138) may be updated and the training process iterated.

More generally, the training data (176) is provided as input to the machine learning model (178), which may be the multi-domain language model (132) of FIG. 1A. The machine learning model (178) may be characterized as a program that has adjustable parameters. The program is capable of learning and recognizing patterns to make predictions. The output of the machine learning model (178) may be changed by changing one or more parameters of the algorithm, such as the parameter (180) of the machine learning model (178). The parameter (180) may be one or more weights, the application of a sigmoid function, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a predetermined end condition of training has been reached. The predetermined end condition may vary based on the type of training objectives being used (supervised versus unsupervised machine learning), or may be predetermined by a user (e.g., convergence occurs after a set number of training iterations, described below).

In the case of supervised machine learning (e.g., the trained supervised machine learning model (144) of FIG. 1A), the convergence process (184) compares the output (182) to a known result (186). The known result (186) is stored in the form of labels for the training data (176). For example, the known result (186) for a particular entry in an output (182) of the machine learning model (178) may be a known value, and that known value is a label that is associated with the training data (176).

Continuing the example of supervised machine learning model training, a determination is made whether the output (182) matches the known result (186) to a predetermined degree. The predetermined degree may be an exact match, a match to within a pre-specified percentage, or some other metric for evaluating how closely the output (182) matches the known result (186). Convergence may occur when the known result (186) matches the output (182) to within a pre-specified percentage. When many predictions are involved (e.g., the training data (176) includes the domain general labeled dataset, and the domain specific labeled dataset, each of which contains numerous queries), then convergence may be determined based on the match results aggregated across the data instances.

For example, the threshold may be 95%. In this case, when the multi-domain language model (132) accuracy reaches 95% (representing that in 95% out of all tokens across all data points exactly match the labels), then convergence occurs.

In the case of unsupervised machine learning, the convergence process (184) may be compared to the output (182) or to a prior output in order to determine a degree to which the current output changed relative to the immediately prior output or to the original output. Once the degree of improvement in model predictions fails to satisfy the threshold degree of change, then the machine learning model may be considered to have achieved convergence. Alternatively, an unsupervised model may use alternatives (such as similarity measures, sequence of next tokens or other patterns in the data) to determine whether a training achieves convergence as described above for a supervised machine learning model.

If convergence has not occurred (a “no” at the convergence process (184)), then a loss function (188) is generated. The loss function (188) is a program that specifies the method for which to compare the model prediction and the labels. The optimization function takes the loss as an input then determines the degree to which each tunable parameter in the model should be adjusted according to the loss and the degree to which each parameter contributes to the prediction. The basis for performing the adjustment is defined by the optimizer. The program may be an algorithm which attempts to estimate how the parameter (180) may be changed in the direction toward improving the overall quality of the predictions so that the next execution of the machine learning model (178), using the training data (176) with the updated parameter (190), will have an output (182) that is more likely to result in convergence. In this manner, the next execution of the machine learning model (178) is more likely to match the known result (186) (supervised learning), or which is more likely to result in an output (182) that more closely approximates the prior output (one unsupervised learning technique), or which otherwise is more likely to result in convergence.

In any case, the optimization function is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment, the trained machine learning model (192) with the trained parameter (194) is executed again, but this time on unknown data for which the final result is not known. The output of the trained machine learning model (192) is then treated as a prediction of the information of interest relative to the unknown data.

While FIG. 1A and FIG. 1B show a configuration of components, other configurations may be used without departing from the scope of one or more embodiments. For example, various components may be combined to create a single component. As another example, the functionality performed by a single component may be performed by two or more components.

FIG. 2 shows a flowchart of a method for content moderation of a primary language model using a trained multi-domain language model, in accordance with one or more embodiments. The method of FIG. 2 may be implemented using the system of FIG. 1A and FIG. 1B. One or more of the steps may be performed on or received from one or more computer processors. In an embodiment, a system may include at least one processor and an application that, when executing on at least one processor, performs the method. In an embodiment, a non-transitory computer readable medium may include instructions that, when executed by one or more processors, perform the method. The outputs from various components (including models, functions, procedures, programs, processors, etc.) performing the method may be generated by applying a transformation of inputs using the components to create the outputs without using mental processes or human activities.

Step 200 includes receiving a query for a primary language model. The prompt may be received from a user device. The prompt may be received via a chatbot interacting with a user device. The prompt may be received from another application process, such as another software application programmed to call the primary language model to generate an output.

Step 202 includes applying a server controller to the query to generate an inference prompt and to identify a query domain. Step 202 may be considered a combination of two sub-steps (i.e., the identification of the query domain and the generation of the inference prompt), or may be considered as two separate steps. However, during step 202, both the query domain is identified, and the inference prompt is generated.

As generation of the inference prompt may involve a determination of the query domain, attention is first turned to identifying the query domain. A variety of different techniques may be used to identify the query domain, depending on the particular implementation in which the method of FIG. 2 is being applied.

For example, the query domain may be associated with the identity of a particular software application from which the query was received. In other words, an application identity associated with the query is identified and the query domain of the query is assigned to the application identity. For example, if the query came from Software X, then the query may be assigned to the “Software X Domain.” However, if the query domain came from software that does not require special content moderation handling, then the query may be assigned to the “domain general” domain.

However, the query domain may be identified according to other methods. For example, the trained multi-domain language model may be applied to the query, along with an instruction to the trained multi-domain language model to identify a domain (from a number of preselected domains) to which the query belongs. Some other language models (including the primary language model), along with an instruction to identify the domain to which the query belongs, also may be applied to the query. In any case, an additional output of the model (e.g., the trained multi-domain language model, the primary model, or some other model) may then be assigned as the query domain of the query.

Still other techniques may be used to assign the query domain to the query. For example, a number of semantic distances may be determined between the query and a number of predetermined query domains stored in a library. The query domain in the library having the closest semantic distance to the semantic meaning of the query may be selected as the query domain in step 202.

Attention is now turned to generation of the inference prompt. Again, the inference prompt is the prompt to be provided to the trained multi-domain language model as part of determining the output decision.

In one embodiment, a general inference prompt may be retrieved from a data source (e.g., a data repository, a non-transitory computer readable storage medium, or some other storage medium). The general inference prompt may be used as the inference prompt. An example of a general inference prompt is shown in FIG. 6.

However, in a more common scenario, a general inference prompt may be retrieved as described above and, in addition, a domain specific prompt may be retrieved from the same or a different data source. In this case, the general inference prompt and the domain specific prompt are combined, such as by concatenation or by inclusion of both prompt types into a single larger prompt. The combined prompt is then used as the inference prompt.

In still another embodiment, the general inference prompt as well as domain specific prompts for the domains available to the trained multi-domain language model. In other words, a single super prompt may be used as the inference prompt, with the super prompt containing the possible combinations of general inference prompts, domain specific prompts, output prompts, etc. At run time, the various sets of layers of the trained multi-domain language model may be executed according to the various prompts (e.g., the general inference prompt being applied to the set of base layers, the domain specific prompts being applied to the various additional domain specific adapter layers, etc.). However, the outputs of the various sets of domain specific adapter layers are combined as described below with respect to step 206.

Step 204 includes selecting a selected set of domain adapter layers from among a set of domain general adapter layers and sets of domain specific adapter layers of a trained multi-domain language model. Selecting the selected set of domain adapter layers may be performed according to the query domain, as follows.

Again, for reference, the trained multi-domain language model includes multiple domains, including a set of base layers (i.e., the set of base layers (120) of FIG. 1A), a set of domain general adapter layers (i.e., the set of domain general adapter layers (121) of FIG. 1A), and multiple sets of domain specific adapter layers (i.e., the set of domain specific adapter layers (122) and the additional sets of domain specific adapter layers (123) of FIG. 1A). A query will be passed through the set of base layers. However, the query will also be passed through a selected set of domain adapter layers.

Each set of layers is assigned to one of the available sets of domain layers to which the query may be assigned. Thus, the query domain, once known, determines which of the set of domain general adapter layers or the sets of domain specific adapter layers will be the selected set of domain adapter layers. For example, if the domain is “Software X”, then the selected set of domain adapter layers may be the set of domain specific adapter layers that were specifically trained to process harm categories that are deemed necessary for “Software X.” usage. However, if the domain is “general harm,” then the selected set of domain adapter layers may be only the set of domain general adapter layers.

Step 204 may be optional in some embodiments, such as when the domain of the query is already known (e.g., the origin of the query is known to be a specific application, the identity of which determines the selected domain). If the selected set of domain adapter layers is already known, then the selected set of domain adapter layers is applied to the query as part of generating the output decision at step 206.

Step 206 includes applying the trained multi-domain language model, including the selected set of domain adapter layers to the inference prompt, to generate an output decision. Step 206 includes providing the inference prompt to the trained multi-domain language model. The inference prompt includes the general inference prompt and the domain specific inference prompt. The general inference prompt instructs the trained multi-domain language model how to apply the set of base layers to the query. The domain specific inference prompt instructs the trained multi-domain language model how to apply the selected set of domain adapter layers to the query. The trained multi-domain language model is then executed according to the instructions in the inference prompt. An example of execution of the trained multi-domain language model is shown in FIG. 3 and FIG. 4.

Step 206 may include applying the inference prompt to the set of base layers and the available domain specific adapter layers, regardless of the query domain to which the query was assigned and regardless of which of the set of domain specific adapter layers is the selected set of domain adapter layers. However, in this embodiment, outputs of the various domain specific adapter layers, other than the selected set of domain adapter layers, are multiplied by zero. In other words, the set of domain specific adapter layers other than the selected set of domain adapter layers are effectively excluded from the determination of the output decision.

A selected output of the selected set of domain adapter layers is combined with a base output of the set of base layers to form the final output of the trained multi-domain language model. The final output of the trained multi-domain language model is the structured text of the content moderation predictions for the selected set of harm categories (based on the domains). In an embodiment, the output text containing content moderation predictions and the output decision based on the combined output may be decoded. The output (or decoded output) is then used to determine the output decision which specifies whether to block the query from reaching the primary language model, permit the query to be transmitted to the primary language model, or to modify the query prior to transmitting the query to the primary language model.

In more detail, as described with respect to FIG. 1A, the trained multi-domain language model may include a set of base layers having a number of pretrained weights, and further include a number of domain adapter layers including a selected set of domain specific adapter layers selected according to the query domain. In this case, step 206 may include passing the query through the set of base layers along with the selected set of domain adapter layers to generate the final outputs. Then, step 206 includes combining the base output and the selected output to generate the output decision.

Attention is now turned to step 208. Step 208 includes routing the query to a routing process according to the output decision. The routing process determines how to treat the query.

In an embodiment, the routing process may block or permit the query from reaching the primary language model according to the combined output (i.e., the output decision). For example, if the combined output is to block, then the query does not reach the primary language model. Instead, an error message may be transmitted to the user device from which the query was received.

However, the routing process also may transmit, or permit transmission of, the query to the primary language model. Thus, when the output decision is a pass decision, the query may be passed to the primary language model. Then, the primary language model may be applied to the query to generate a primary language model output. The primary language model output may be transmitted back to the user device from which the query was received.

Other variations are possible at step 208. For example, the output decision may be a conditional pass determination. In this case, the query may be modified before transmission to the primary language model. The modified prompt may be deemed to be a more appropriate prompt for the primary language model. The user device may be modified so that the modified prompt is being submitted to the primary language model. In an embodiment, permission may be sought from the user device to use the modified query. If permission is denied, then the original query may be blocked or the user may be prompted to revise the original query.

In any case, if the modified query is to be used, then the modified query is passed to the primary language model. Then, the primary language model is applied to the modified query, and the subsequent output of the primary language model is returned to the user device as described above.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

Attention is now turned to FIG. 3 and FIG. 4, which are examples of the multi-domain language model (118) of FIG. 1A. FIG. 3 shows an overview of one example of using the trained multi-domain language model. FIG. 4 shows additional details of the trained multi-domain language model and the corresponding use. Because FIG. 3 and FIG. 4 may refer to the same trained multi-domain language model, in an embodiment, reference numerals in common between FIG. 3 and FIG. 4 refer to similar components having similar descriptions.

FIG. 3 shows the trained multi-domain language model (300). The trained multi-domain language model (300) includes a set of base layers (302), which may be the set of base layers (120) of FIG. 1A. The trained multi-domain language model (300) also includes a number of sets of domain adapter layers, including a set of domain general adapter layers (304), first set of domain specific adapter layers (306), and second set of domain specific adapter layers (308). Thus, the trained multi-domain language model (300) includes four sets of layers: a set of base layers, a set of domain general adapter layers, a first set of domain specific adapter layers, and a second set of domain specific adapter layers. As can be seen in FIG. 3, each domain has multiple layers of code. Thus, each domain is referred to as “a set of layers.”

In use, an inference prompt (310) is provided as input to the trained multi-domain language model (300). The inference prompt (310) includes at least general instructions (i.e., a general inference prompt) and a reference to the query that is being considered by the trained multi-domain language model (300). Upon execution, the various sets of layers of the trained multi-domain language model (300) analyze the query according to the instructions in the inference prompt (310), and according to the domain to which the query was assigned (the domains being “general,” “first domain,” or “second domain”).

The output of the trained multi-domain language model (300) is an output decision (312). The output decision (312) may be to block the query from being transmitted to a primary language model, permit the query to be input to the primary language model, or modify the query before permitting a modified query to be input to the primary language model.

FIG. 4 shows details of the architecture and operation of a trained multi-domain language model. Thus, the trained multi-domain language model (400) may be the trained multi-domain language model (300) of FIG. 3. Specifically, the trained multi-domain language model (400), as shown in FIG. 4, is a large language model with multiple sets of LoRA adapter layers.

Note that the trained multi-domain language model (300) of FIG. 3 may be a different type of multi-domain language model. However, for ease of reference, FIG. 4 is presented as a more detailed version of the trained multi-domain language model (300) shown in FIG. 3.

Thus, the trained multi-domain language model (400) also includes a set of base layers (302), a set of domain general adapter layers (304), first set of domain specific adapter layers (306), and second set of domain specific adapter layers (308). Each of the sets of layers are frozen, as indicated by snowflake symbols, such as snowflake symbol (402). The term “frozen” means that the programming of the layers of the domains does not change at the time the trained multi-domain language model (400) is called upon to execute (i.e., during the inference phase of machine learning).

However, during training, the various sets of layers may be unfrozen and adjusted during the training process described in FIG. 1B. In particular, the set of base layers (302) may be trained, with weights of the layers adjusted according to the training process described in FIG. 1B. Thereafter, the sets of domain specific adapter layers are frozen, except for one set of domain specific adapter layers. Then, training data corresponding to the same domain as the set of domain specific adapter layers being trained is used to train the one set of domain specific adapter layers. Each of the set of domain specific adapter layers is trained in a similar fashion, either in parallel or serially, or some combination thereof.

At inference time, a query (404) is received. A server controller then performs a domain determination process (406) to determine the query domain to which the query (404) belongs. The domain may be one of “general,” “first domain,” and “second domain.”

Then, an inference prompt (408) is generated according to the domain to which the query (404) belongs. The inference prompt (408) includes a reference to the query (404), a general inference prompt, and a domain specific prompt. See FIG. 6 for an example of such a prompt.

In the example of FIG. 4, the inference prompt (408) serves as input to each of the sets of sets of layers that are used during execution of the trained multi-domain language model (400). Thus, the inference prompt (408) is input to the set of base layers (302). The inference prompt (408) is also input to the set of domain general adapter layers (304) when the domain of the query (404) is “general.” The inference prompt (408) is input to the first set of domain specific adapter layers (306) when the domain of the query (404) is “first domain.” The inference prompt (408) is input to the second set of domain specific adapter layers (308) when the domain of the query (404) is “second domain.”

Each corresponding set of sets of layers outputs a number or text, depending on the type of model, as shown at output layer (410). Because the trained multi-domain language model (400) in FIG. 4 is a large language model with multi-LoRA adapter layers, the output of each layer is text in a format that may be determined by instructions in the inference prompt (408). The text may be “block” or “permit,” possibly together with other output requested by the inference prompt (408). In an alternative, in the case that the trained multi-domain language model (400) outputs a number, the number is a determined probability that the query (404) should be blocked (or a number reflecting a probability that the query (404) should be permitted).

However, in either case, the final output of the trained multi-domain language model (400) is a combination of the outputs of each of the sets of sets of layers. Before performing that combination, although each of the sets of layers may execute on the inference prompt (408), the outputs of some of the sets of domain specific adapter layers may be discarded. In particular, the outputs of each of the sets of domain specific adapter layers are discarded, except for the selected set of domain adapter layers.

For example, assume that the first set of domain specific adapter layers (306) is the selected set of domain adapter layers. In this case, the output of the set of domain general adapter layers (304) and the output of the second set of domain specific adapter layers (308) are discarded (e.g., multiplied by zero). The output of the first set of domain specific adapter layers (306) is retained. The output of the set of base layers (302) is then combined with the output of the first set of domain specific adapter layers (306) layer by layer.

In any case, the combination of the outputs of the set of base layers (302) and the first set of domain specific adapter layers (306) is the combined output (412) of the trained multi-domain language model (400). The combined output (412) serves as an input to the decoding head that generates the structured text outputs (sequence of tokens) that contains the content moderation predictions and the output decision (414). For example, the output decision (414) may be to block or permit the query (404) from transmission to the primary language model.

Viewing the operation of the trained multi-domain language model (400) as a whole, the first set of domain specific adapter layers (306) were trained on training data in the same domain that the query domain determined for the query (404). Thus, the first set of domain specific adapter layers (306) accomplishes a similar effect on the final output of the model as would a model trained entirely on a domain specific data set. Because the trained multi-domain language model (400) includes multiple domain specific sets of layers, the trained multi-domain language model (400) provides a single content moderation model. Accordingly, the trained multi-domain language model (400) may obviate the desire for multiple domain specific models for content moderation of a primary language model, with attendant cost savings for the organization.

Attention is now turned to FIG. 5, which shows a data flow for using a trained multi-domain language model for content moderation of a primary language model, in accordance with one or more embodiments. Initially, at step (500), a query is received for a primary language model. The user submitting the query may be unaware that the query is intercepted by the data flow of FIG. 5.

Next, a server controller (502) determines a query domain (504) for the query received at step (500). The query domain may be determined as described with respect to step 202 of FIG. 2. In the example of FIG. 5, the possible query domains are the names of software programs from which the query may originate. In the example, the query domain (504) corresponds to “Gamma Software,” as the query received at step (500) was received from a user's interaction with Gamma Software.

Next, the server controller (502) determines the contents of an inference prompt (506). Specifically, the server controller (502) retrieves a general inference prompt (510) and a selected domain inference prompt from among the various domain inference prompts available between domain inference prompt 1 (512) and domain inference prompt N (514). The general inference prompt (510) may apply regardless of the domain to which the query is assigned (e.g., a system message, and output section, etc.). The domain inference prompt may be a prompt to be used when the query is assigned to one of the “domain general” domain or one of the “domain specific” domains.

The server controller (502) combines the selected domain inference prompt with the general inference prompt. In addition, the server controller (502) adds a reference to the query retrieved at step (500) to the inference prompt (506). The server controller (502) also adds an output prompt to the inference prompt (506) in order to cause the trained multi-domain language model (516) to format an output in a particular desired format. In particular, the output prompt instructs the trained multi-domain language model (516) to format the final output in an object notation language, such as a JAVASCRIPT® object notation (JSON) data structure.

The inference prompt (506) then serves as input to the trained multi-domain language model (516). The trained multi-domain language model (516) includes a number of sets of layers to be applied to a query based on a domain to which the query belongs. The sets of layers include a set of base layers (518) and a number of sets of domain adapter layers, such as a set of domain general adapter layers (520) and set of domain specific adapter layers N (522), and a number of additional sets of domain specific adapter layers, as indicated by the ellipsis shown in FIG. 5.

One of the sets of domain adapter layers is selected from the set of domain general adapter layers (520) or one of the available sets of domain specific adapter layers (e.g., the set of domain specific adapter layers N (522)). The selection of the selected set of domain adapter layers (524) proceeds as follows. The inference prompt (506) contains an indication that the query received at step (500) is in the Gamma Software domain. In the example, the selected set of domain adapter layers (524) is the set of domain specific adapter layers trained on known queries received at Gamma Software (which is the set of domain specific adapter layers N (522) in this example).

The inference prompt (506) instructs the trained multi-domain language model (516) to exclude the outputs of the sets of domain specific adapter layers, other than the selected set of domain adapter layers (524). In this manner, the output of the selected set of domain adapter layers (524) will factor into the ultimate output of the trained multi-domain language model (516), but the outputs of the remaining sets of domain specific adapter layers will not factor into the ultimate output of the trained multi-domain language model (516).

The ultimate output of the trained multi-domain language model (516) is the structured text generated from the decoding head using the combined output (526) as an input. Specifically, the combined output (526) is a combination of the output of the set of base layers (518) and the output of the selected set of domain adapter layers (524).

Note that, in an alternate embodiment, the query received at step 500 could have been assigned to the “domain general” domain. For example, the query could have been in a domain general category, such as abusive language, that applies across all available domains. In this case, the selected set of domain adapter layers (524) would have been the set of domain general adapter layers (520) without the one of the sets of domain specific adapter layers (e.g., the domain specific adapter layers N (522)).

In any case, the combined output (526) is submitted to a routing process (528). The routing process (528) determines whether to permit or block the query received at step (500). Thus, the combined output (526) may cause the decoding head to generate the output decision structured text that includes the word “block” or the word “permit.”

If the output decision includes the word “block,” then the routing process (528) blocks the query according to a blocking process (530). The blocking process (530) may prevent the query from being transmitted to a primary language model. In addition, the blocking process (530) also generates an error message (512) using the block decision. The blocking process (530) also may determine a reason the query was not appropriate (such as submitting the query to some other language model to determine why the query was not appropriate). The error message (512) is transmitted to the user device from which the query was received. The error message (512) may state, for example, that the query was “off topic,” and suggest that a revised query be submitted. The data flow may terminate thereafter.

If the combined output (526) includes the word “permit,” then the routing process (528) permits the query to be transmitted to a primary language model (534). The routing process (528) alternatively may actively transmit the query to the primary language model (534). The primary language model (534) is then applied to the query. The output of the primary language model (534) is a primary language model output (536). The primary language model output (536) is transmitted to the user device from which the query was received. The data flow may terminate thereafter.

In an alternative, the routing process (528) may determine that the query may be modified in order for the query to be deemed appropriate for the primary language model (534). For example, a modification process (538) may determine a most likely phrasing of the original query that conveys the intent of the original query, with the rephrased prompt being an appropriate query. The modification process (538) may be, for example, another large language model.

The modification process (538) generates a modified prompt (540). In an embodiment, the modified prompt (540) is passed to the primary language model (534), which then generates the primary language model output (536) as described above, and the data flow may terminate.

Alternatively, the modified prompt (540) may be returned to the user device from which the query was received. The user may also be prompted to accept or reject the modified prompt (540), or to generate a new query. If the user accepts the modified prompt (540), then the modified prompt is transmitted to the primary language model (534) in order to generate the primary language model output (536), as described above. The data flow may terminate thereafter.

FIG. 6 shows an example of a prompt (680) usable during training or inference of a multi-domain language model, in accordance with one or more embodiments. The prompt (680) may be used during the training of the trained multi-domain language model (118) described with respect to FIG. 1A or the multi-domain language model (516) described with respect to FIG. 5. The prompt (680) also may be used during an inference phase after the training process. In other words, the prompt (680) may be used when applying a multi-domain language model to an unknown query submitted to a primary language model in order to generate a content moderation prediction that can be used to determine whether the unknown query should be blocked or permitted.

The prompt includes five sections. A system message (682) provides general instructions to the multi-domain language model, as shown. The system message (682) may limit how the language model determines the output of “block” or “permit.”

A domain general instruction (684) instructs the multi-domain language model regarding general harms that may apply to each of the domain distinct sets of layers in the multi-domain language model. Domain general harms may include prompt injection attacks, profanity, toxic messages, etc. The domain general instruction (684) may limit how domain general adapter layers are applied to generate the content moderation prediction that can be used to determine whether to “block” or “permit.”

A domain specific instruction (686) instructs the multi-domain language model regarding specific harms that may apply to one of the sets of domain specific adapter layers in the multi-domain language model, but not necessarily other sets of domain specific adapter layers in the multi-domain language model. Domain specific harms may include queries that are off topic (e.g., a tax question submitted to marketing software), or may include queries related to prohibited advice for the domain (e.g., asking for legal advice that only a licensed lawyer could give).

Additional domain specific instructions also may be present. In an embodiment, one set of domain specific instructions is present for each set of domain specific adapter layers.

A content section (688) contains the content to be moderated (i.e., the content for which the prediction will be performed). For example, the content section (688) may contain the query for which content moderation predictions are based on (i.e., the content is the queries). The content section (688) may also reference a database from which the language model may retrieve the content to be moderated.

An output structure instruction (690) instructs the multi-domain language model regarding how the multi-domain language model should return the final output (i.e., the prediction for the query). As shown, the output may be presented in a structured object notation data file (e.g., a JSON file (JSON stands for JAVASCRIPT® object notation)). The relative harm represented by the query may be represented by a number between 1 and 10. An example input and an example output are provided in the output structure instruction (690) so that the multi-domain language model may return other predictions in a similar manner.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 7A, the computing system (700) may include one or more computer processor(s) (702), non-persistent storage device(s) (704), persistent storage device(s) (706), a communication interface (708) (e.g., Bluetooth interface, infrared interface, network interface, optical interface, etc.), and numerous other elements and functionalities that implement the features and elements of the disclosure. The computer processor(s) (702) may be an integrated circuit for processing instructions. The computer processor(s) (702) may be one or more cores, or micro-cores, of a processor. The computer processor(s) (702) includes one or more processors. The computer processor(s) (702) may include a central processing unit (CPU), a graphics processing unit (GPU), a tensor processing unit (TPU), combinations thereof, etc.

The input device(s) (710) may include a touchscreen, keyboard, mouse, microphone, touchpad, electronic pen, or any other type of input device. The input device(s) (710) may receive inputs from a user that are responsive to data and messages presented by the output device(s) (712). The inputs may include text input, audio input, video input, etc., which may be processed and transmitted by the computing system (700) in accordance with one or more embodiments. The communication interface (708) may include an integrated circuit for connecting the computing system (700) to a network (not shown) (e.g., a local area network (LAN), a wide area network (WAN) such as the Internet, mobile network, or any other type of network) or to another device, such as another computing device, and combinations thereof.

Further, the output device(s) (712) may include a display device, a printer, external storage, or any other output device. One or more of the output device(s) (712) may be the same or different from the input device(s) (710). The input device(s) (710) and output device(s) (712) may be locally or remotely connected to the computer processor(s) (702). Many different types of computing systems exist, and the aforementioned input device(s) (710) and output device(s) (712) may take other forms. The output device(s) (712) may display data and messages that are transmitted and received by the computing system (700). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (702), is configured to perform one or more embodiments, which may include transmitting, receiving, presenting, and displaying data and messages described in the other figures of the disclosure.

The computing system (700) in FIG. 7A may be connected to, or be a part of, a network. For example, as shown in FIG. 7B, the network (720) may include multiple nodes (e.g., node X (722) and node Y (724), as well as extant intervening nodes between node X (722) and node Y (724)). Each node may correspond to a computing system, such as the computing system shown in FIG. 7A, or a group of nodes combined may correspond to the computing system shown in FIG. 7A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (700) may be located at a remote location and connected to the other elements over a network.

The nodes (e.g., node X (722) and node Y (724)) in the network (720) may be configured to provide services for a client device (726). The services may include receiving requests and transmitting responses to the client device (726). For example, the nodes may be part of a cloud computing system. The client device (726) may be a computing system, such as the computing system shown in FIG. 7A. Further, the client device (726) may include or perform all or a portion of one or more embodiments.

The computing system of FIG. 7A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a query for a primary language model;
applying a server controller to the query to generate an inference prompt and to identify a query domain;
applying a trained multi-domain language model to the inference prompt according to the inference prompt and the query domain to generate an output decision; and
routing the query to a routing process according to the output decision.

2. The method of claim 1, wherein the trained multi-domain language model comprises a set of base layers, a set of domain general adapter layers, and a plurality of sets of domain specific adapter layers, and wherein the method further comprises:
selecting, prior to applying the trained multi-domain language model to the inference prompt, a selected set of domain adapter layers from among the set of domain general adapter layers and the plurality of sets of domain specific adapter layers.

3. The method of claim 2, wherein applying the trained multi-domain language model further comprises:
applying the inference prompt to the set of base layers, the set of domain general adapter layers, and the plurality of sets of domain specific adapter layers,
multiplying, by zero, outputs of the set of domain general adapter layers and the plurality of sets of domain specific adapter layers, other than the selected set of domain adapter layers,
combining, into a combined output, a selected output of the selected set of domain adapter layers with a base output of the set of base layers, wherein the combined output comprises generated text containing a content moderation prediction and the output decision, and
decoding the combined output to generate decoded output, wherein routing comprises blocking or permitting the query according to the decoded output.

4. The method of claim 1, wherein the routing process comprises:
blocking, responsive to the output decision comprising a block decision, the query from the primary language model.

5. The method of claim 1, wherein the routing process comprises:
blocking, responsive to the output decision comprising a block decision, the query from the primary language model, and
transmitting an error message to a user device from which the query was received.

6. The method of claim 1, wherein the routing process comprises:
transmitting, responsive to the output decision comprising a pass decision, the query to the primary language model.

7. The method of claim 1, wherein the routing process comprises:
transmitting, responsive to the output decision comprising a pass decision, the query to the primary language model,
applying the primary language model to the query to generate a primary language model output, and
transmitting the primary language model output to a user device.

8. The method of claim 1, wherein the routing process comprises:
modifying the query to generate a modified query, and
transmitting the modified query to the primary language model.

9. The method of claim 1, wherein applying the server controller to the query to generate the inference prompt comprises:
retrieving a general inference prompt, and
using the general inference prompt as the query.

10. The method of claim 1, wherein applying the server controller to the query to generate the inference prompt comprises:
retrieving a general inference prompt,
selecting a selected domain for the query,
retrieving a domain specific prompt according to the selected domain,
combining the general inference prompt and the domain specific prompt into a combined prompt, and
using the combined prompt as the inference prompt.

11. The method of claim 1, wherein applying the server controller to the query to identify the query domain comprises:
applying the query to the trained multi-domain language model, and
receiving, as an additional output of the trained multi-domain language model, the query domain.

12. The method of claim 1, wherein applying the server controller to the query to identify the query domain comprises:
identifying an application identity associated with the query, and
assigning the query domain according to the application identity.

13. The method of claim 1, wherein the trained multi-domain language model comprises a set of base layers having a plurality of pretrained weights, and further comprises a plurality of sets of domain specific adapter layers including a selected set of domain adapter layers selected according to the query domain, and wherein the method further comprises:
passing the query through the set of base layers to generate a base output,
passing the query through the plurality of sets of domain specific adapter layers to generate a plurality of domain adapter layer outputs,
discarding, other than a selected output of the selected set of domain adapter layers, each of the plurality of domain adapter layer outputs, wherein the selected output is retained, and
combining the base output and the selected output to generate the output decision.

14. A system comprising:
a processor;
a data repository in communication with the processor, and storing:
a query for a primary language model,
an inference prompt,
a query domain, and
an output decision;
a server controller which, when executed by the processor:
receives the query, and
generates the inference prompt and identifies the query domain;
a trained multi-domain language model which, when executed by the processor, generates the output decision; and
a routing process which, when executed by the processor, routes the query according to the output decision.

15. The system of claim 14, further comprising:
the primary language model.

16. The system of claim 14, wherein the trained multi-domain language model comprises a set of base layers, a set of domain general adapter layers, and a plurality of sets of domain specific adapter layers, and wherein the server controller further:
selects, prior to applying the trained multi-domain language model to the inference prompt, a selected set of domain adapter layers from among the set of domain general adapter layers and the plurality of sets of domain specific adapter layers.

17. The system of claim 16, wherein the trained multi-domain language model further:
applies the inference prompt to the set of base layers, the set of domain general adapter layers, and the plurality of sets of domain specific adapter layers,
multiplies, by zero, outputs of the set of domain general adapter layers and the plurality of sets of domain specific adapter layers, other than the selected set of domain adapter layers,
combines, into a combined output, a selected output of the selected set of domain adapter layers with a base output of the set of base layers, and
generates structured text, containing a content moderation prediction and the output decision, based on the combined output,
wherein routing comprises blocking or permitting the query according to the structured text.

18. The system of claim 14, wherein the routing process further:
blocks, responsive to the output decision comprising a block decision, the query from the primary language model.

19. The system of claim 14, wherein the routing process further:
transmits, responsive to the output decision comprising a pass decision, the query to the primary language model,
applies the primary language model to the query to generate a primary language model output, and
transmits the primary language model output to a user device.

20. A method comprising:
receiving a query for a primary language model;
applying a server controller to the query to generate an inference prompt and to identify a query domain;
selecting a selected set of domain adapter layers from among a set of domain general adapter layers and a plurality of sets of domain specific adapter layers of a trained multi-domain language model, wherein the trained multi-domain language model further comprises a set of base layers separate from the set of domain general adapter layers and the plurality of sets of domain specific adapter layers;
applying the trained multi-domain language model to the query according to the inference prompt and the query domain to generate an output decision, wherein applying the trained multi-domain language model further comprises:
applying the inference prompt to the set of base layers, the set of domain general adapter layers, and the plurality of sets of domain specific adapter layers,
multiplying, by zero, outputs of the set of domain general adapter layers and the plurality of sets of domain specific adapter layers, other than the selected set of domain adapter layers,
combining, into a combined output, a selected output of the selected set of domain adapter layers with a base output of the set of base layers, and
generating structured text, containing a content moderation prediction and the output decision, based on the combined output; and
routing the query to a routing process according to the output decision, wherein routing further comprises blocking or permitting the query from reaching the primary language model according to the structured text.
